(19) United States
(12) Patent Application Publication
(10) Pub. No.: US 2009/0029702 A1
(43) Pub. Date: Jan. 29, 2009

(54) System and Method for Collecting and Analyzing User Information

(75) Inventor: Wei Shen, Beijing (CN)

Correspondence Address: LERNER GREENBERG STEMER LLP, P O BOX 2480, HOLLYWOOD, FL, 33022-2480, US

(73) Assignee: GMEDIA CORPORATION, Grand Cayman (KY)

(21) Appl. No.: 12/295,652

(22) PCT Filed: Mar. 19, 2007
(86) PCT No.: PCT/CN2007/000886

§ 371 Date: Oct. 1, 2008

(30) Foreign Application Priority Data
Apr. 4, 2006 (CN) 200610067087.X

(51) Int. Cl. H04W 4/00

(52) U.S. Cl. 455/435.1

(57) ABSTRACT

The present invention is to provide system and method for collecting and analyzing user information. The system comprises an information carrier, for carrying information; a mobile terminal, comprising an information reading apparatus for reading information on the information carrier; and an ID storing device for storing the ID of the mobile terminal; a communication network; and an information server which receives the information on the information carrier and the ID of the mobile terminal from the mobile terminal through the communication network, and performs a statistics and analysis thereon. The present invention can achieve real-time and continuous information collection and analysis, and may also push advertisement information to users based on the collection and analysis of the information instantly or conditionally.

### TECHNICAL FIELD

The present invention relates to system and method for collecting and analyzing user information and for marketing using mobile terminals (especially mobile phones) and a network.

### BACKGROUND ARTS

Recently, Internet has been widely used, and accessing Internet through mobile phones is also popularized gradually. People can enjoy a variety of services through Internet, such as shopping, booking hotels, browsing information. Meanwhile, papers, magazines and posters are publishing more and more advertisements with URLs to direct people to access related web pages and obtain more information.

However, to access a network, a user has to perform operations such as inputting URLs on a terminal device and so on. For a mobile phone user, such complicated operations for accessing the network are quite cumbersome. However, for a computer terminal which is relatively convenient for the operation of inputting the URLs, it is often the case that the user does not take along the computer terminal when he is reading the advertisements. Therefore, this would impact the effect of advertising and promoting using URLs.

Due to the development of camera mobile phones, the application of identifying barcodes (including one-dimensional codes, two-dimensional codes and the like) via camera lens of mobile phones and obtaining related information from a network is increasing. That is, to print or display barcodes on printed matters, packaging, outdoor media and television and computer screens, identify the barcodes via the camera lens of the mobile phones, and obtain information from the network.

When a user is using a mobile phone to connect to a network, the mobile operators and the mobile content service provider can obtain data such as the user's mobile phone number and mobile phone model, perform an analysis on the user according to the contents that the user accesses, access time, mobile phone model and the like, and carry out marketing accordingly. However, this method can only perform user analysis according to the data obtained after they accessed the website, and can not analyze the source of users directed, for example, by which media or advertisement.

The patent document [publication No.] CN 1503176A discloses a product information providing system, in which, a user inputs his/her general information using a mobile phone, and sends the general user information and the information of the product he/she holds through the network; the system receives the information, performs an analysis on the user information and sends appropriate product information to the user. The system can also perform a market analysis on the products, and send the results to the advertisers. The main drawback of the system is that the users need to register and provide personal information, and the service provider needs to pay the registered users. Therefore, what the system addresses is real-time product investigation. This patent application discloses a product information reading apparatus for reading product information from product information carriers fixed on products. The product information carriers, for example, product barcodes are originally on the products. Therefore, only the inherent information of the products can be read. Since the document mentions neither collecting the information like users' mobile phone numbers and mobile phone models, nor generating the information carriers (such as one-dimensional barcodes and two-dimensional codes), the system can not be applied to the broad user information collection and analysis. The product information carrier in this document is taken along by the product itself, and can not be self-generated.

The patent document [publication No.] CN 1632811 discloses an advertisement information collecting and analyzing system, comprising: an advertisement information carrier for carrying the advertisement information, for example, advertising media, advertising territory, advertiser, related contents or index of the advertisement and the like; an information writing apparatus for performing information generating of the advertisement information carrier; an information reading apparatus for reading the information on the advertisement information carrier; a mobile terminal for receiving and transmitting information through a network, the mobile terminal having the information reading apparatus, an apparatus for obtaining location information of the mobile terminal, and an apparatus for obtaining time when the mobile terminal sends the advertisement information. The advertisement information carrier in this invention can be generated according to different media, territories, advertisement contents and advertisers, and can be conditionally associated with the location information of the mobile phone and the sending time information, and therefore makes the advertisement monitoring and analyzing more real-time, comprehensive and accurate.

However, the document mentions neither collecting users' mobile phone numbers and mobile phone models, nor the analysis to individual behavior of users and the advertisement marketing technologies based on the analysis. A mobile phone number is an ID to determine the unique identity of a user. Only by getting the ID, information collecting and analyzing for each user, and pushing advertisement information to the users by the mobile phone numbers can be performed.

### SUMMARY OF THE INVENTION

The object of the present invention is to provide system and method for collecting and analyzing user information and for marketing, which can achieve real-time and continuous information collection and analysis, and may also push advertisement information to users based on the collection and analysis of the information instantly or conditionally.

To achieve the object, the present invention utilizes a technical solution as follows: a system for collecting and analyzing user information and for marketing, comprising: a mobile terminal transmitting and receiving information through a network; an information carrier for carrying information; an information server for storing, matching and analyzing information; an advertisement server for transmitting advertisement information to the mobile terminal of a user; an information terminal for receiving the information and analysis data from the information server through the network, and interacting with the information server and the advertisement server; wherein the mobile terminal is equipped with an information reading apparatus which reads the information on the information carrier; the mobile terminal transmits the information and its ID number to the information server through the network; the information server performs a statistics and analysis on the information and the ID numbers of the mobile terminals, and transmits the result of the statistics and analysis to the information terminal according to the request of the information terminal, and transmits one or more mobile terminal (mobile phone) numbers to the advertisement server; and the advertisement server associates the mobile phone ID numbers and the advertisement information, and pushes the advertisement information to the mobile terminals of users through the network.

The information carrier is formed of encodable and automatically identifiable carriers such as barcode, two-dimensional code, RFID and so on.

The information reading apparatus is a non-contact and automatic identifying apparatus such as a digital camera, a barcode identifying device, a RFID identifying device and so on.

The information server includes a storing device and an analyzing apparatus.

The storing device is used to store the information on the information carriers and the ID numbers of mobile terminals; the analyzing apparatus is used to perform the statistics and analysis on the information on the information carriers and the IDs of mobile terminals, and can transmit the result of the statistics and analysis to the information terminal according to the request of the information terminal, or transmit one or more mobile terminal ID numbers to the advertisement server.

The advertisement server includes a storage device, an associating apparatus and a transmitting apparatus.

The storage device is used to store the mobile terminal ID numbers from the information server, and one or more sets of advertisement information as well; the associating apparatus is used to associate the mobile phone numbers and the advertisement information according to a condition; the transmitting apparatus is used to push the advertisement information to the associated mobile phone numbers of the mobile terminals through the network.

A method for collecting and analyzing user information and for marketing, comprising:

step 1, an information reading apparatus of a mobile terminal reading information on an information carrier;
step 2, the mobile terminal transmitting the information and its ID number to an information server through a network;
step 3, the information server performing a statistics and analysis on the information and the ID numbers of mobile terminals;
step 4, transmitting the result of the statistics and analysis to an information terminal according to its request, and transmitting one or more mobile phone numbers of the mobile terminals to an advertisement server;
step 5, the advertisement server associating the mobile phone ID numbers and the advertisement information, and pushing the advertisement information to users' mobile terminals through the network.

The effect of the invention is to provide the advertisers and enterprises with a dynamic, continuous and low-cost method for analyzing the consuming behavior of users through reading the information on information carriers (which are low-cost and easy to implement (e.g., barcode, two-dimensional code and RFID)) by mobile terminals and associating the information on information carriers with unique IDs of the mobile terminals (e.g., mobile phone numbers), and may perform more accurate advertisement marketing on users according to the analysis data.

According to one aspect of the present invention, a system for collecting and analyzing user information is provided, which comprises an information carrier, for carrying information; a mobile terminal comprising an information reading apparatus for reading information on the information carrier and an ID storing device for storing the ID of the mobile terminal; a communication network; and an information server which receives the information on the information carrier and the ID of the mobile terminal from the mobile terminal through the communication network, and performs a statistics and analysis thereon.

The system may further comprise an advertisement server, which receives the ID of the mobile terminal from the information server and transmits advertisement information to the mobile terminal through the communication network, the advertisement server comprising: an storing device for storing the advertisement information and the ID; an associating apparatus for associating the ID and the advertisement information according to a condition; and a transmitting apparatus for pushing the advertisement information to the mobile terminal through the communication network according to the associated ID and the advertisement information.

The system may further comprise an information terminal which requests that the information server transmits the statistics and analysis result to the information terminal and controls the information server and the advertisement server.

According to another aspect of the present invention, a method for collecting and analyzing user information is provided, which comprises: a mobile terminal reading information on an information carrier; the mobile terminal transmitting the read information and its ID to an information server through a communication network; and the information server performing a statistics and analysis on the information on the information carrier and the ID of the mobile terminal received.

The method may further comprise: the information server transmitting the ID of the mobile terminal to an advertisement server; the advertisement server associating the ID and advertisement information; and pushing the advertisement information to the mobile terminal through the communication network according to the associated ID and advertisement information.

The method may further comprise: an information terminal requesting that the information server transmits the statistics and analysis result to the information terminal, and controlling the information server and the advertisement server.

The ID of the mobile terminal is selected from a group consisting of mobile terminal number, mobile terminal model and the combination thereof. The information reading apparatus includes a non-contact and automatic identifying apparatus which is selected from a group consisting of a digital camera, a barcode identifying device and a RFID identifying device.

### DESCRIPTION OF THE DRAWINGS

In order to understand the manner in which examples of the present invention are obtained, a more particular description of various examples of the invention briefly described above will be rendered by reference to the appended drawings. Understanding that these drawings depict only typical examples of the invention that are not necessarily drawn to scale and are not therefore to be considered to be limited of its scope, the examples of the invention will be described and explained with additional specificity and detail through the use of the accompanying drawings in which:

FIG. 1 is a flow chart of a system of the present invention for collecting and analyzing user information and for marketing;

FIG. 2 is a schematic diagram of an analyzing method of example 1 of the present invention;

FIG. 3 is a schematic diagram of another analyzing method of the example 1 of the present invention; and

FIG. 4 is a flow chart showing a method for collecting and analyzing user information and for marketing in accordance with the present invention.

### DETAILED EMBODIMENTS

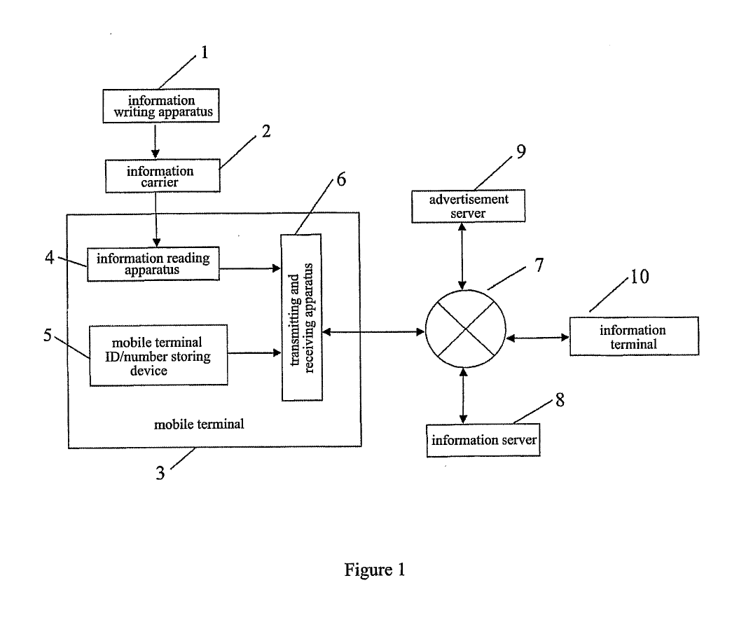

As is showed in FIG. 1, an information writing apparatus (1) writes information into an information carrier (2). The information on the information carrier (2) is read by an information reading apparatus which is built in or connected to a mobile terminal (3). The information carrier may be encoded with information such as information carrier ID, enterprise name/number, product name/number, specification information, network linkage address, implementing media name/number. The information on the information carrier is associated with ID information (for example, a mobile phone number, model, etc.) in a mobile phone ID/number storing device (5). Then, a part or an entirety of the information is transmitted to an information server (8) through a network (7), wherein a part of the information such as mobile phone ID sometimes needs to be processed by a mobile gateway before being transmitted to the information server (8).

As mentioned above, the ID of the mobile terminal may be the mobile phone number or the model of the terminal, but the present invention is not limited in this respect. The ID of the terminal may be the mobile terminal's User Agent (UA) data, the mobile phone number, the International Mobile Equipment Identity (IMEI), the Mobile Country Code (MCC), the Mobile Network Code (MNC), the Location Area Code (LAC) and the like, or even a combination thereof.

The information server (8) is comprised of: a storing device for storing the identified information on the information carriers and the IDs of the mobile terminals (for example, the mobile phone numbers); an analyzing apparatus for performing a statistics and analysis on the identified information on the information carrier (2) and the IDs of the mobile terminals, and transmitting the result of the statistics and analysis to an information terminal (10) based on the request of the information terminal, or transmitting one or more mobile phone numbers of the mobile terminals to an advertisement server (9).

The advertisement server (9) is comprised of: a storing device for storing the mobile phone numbers of the mobile terminals from the information server, and the storing device being able to store one or more sets of advertisement information as well; an associating apparatus for associating the mobile phone numbers and the advertisement information based on a condition; a transmitting apparatus for pushing the advertisement contents to the associated mobile phone numbers of the mobile terminals through the network.

The advertisement server and the information server in the example 1 can be separate servers or a bank of servers, and can also be one server which integrates all the apparatuses and functions.

The information terminal (10) can be one terminal which controls all the functions, and can also be a set of terminals which control the information server and advertisement server respectively.

A method for collecting and analyzing user information and for marketing, comprising following steps:

step 1, an information reading apparatus of a mobile terminal reading information on an information carrier;
step 2, the mobile terminal transmitting the information and its ID number to an information server through a network;
step 3, the information server performing a statistics and analysis on the information and the ID numbers of mobile terminals;
step 4, transmitting the result of the statistics and analysis to an information terminal according to its request, and transmitting one or more mobile phone numbers of the mobile terminals to an advertisement server;
step 5, the advertisement server associating the mobile phone ID numbers and the advertisement information, and pushing the advertisement information to users' mobile terminals through the network.

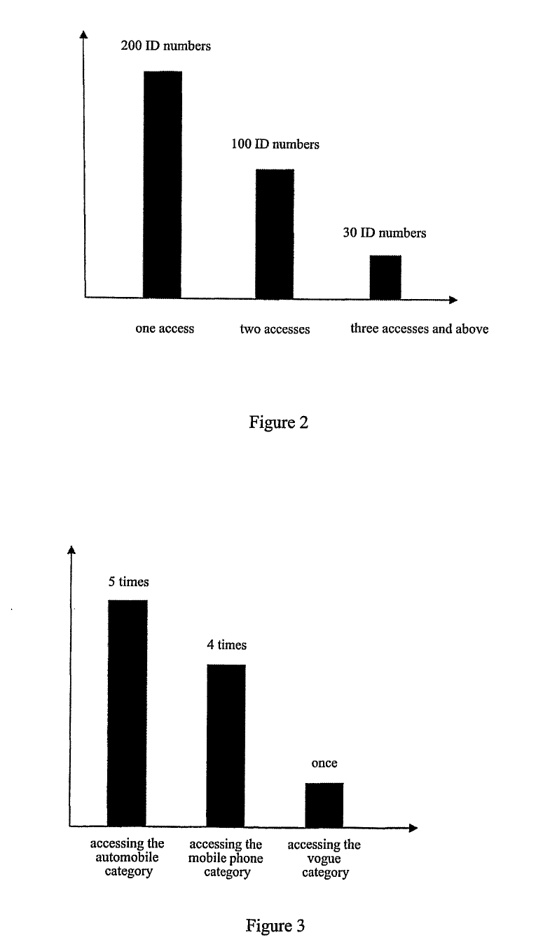

FIG. 2 illustrates a user information analyzing method of the system for collecting and analyzing user information and for marketing of example 1. This method uses one information carrier to collect information, and according to the accessing times of mobile terminals, records the mobile terminal IDs which accessed for once, twice, three times and above. According to the difference of accessing times, the degree of attentions which the users who own the mobile terminals pay to the information carrier and the related advertisement can be determined, so that the advertisement information could be transmitted to the mobile terminals in the light of predetermined or instantly inputted conditions.

FIG. 3 illustrates another user information analyzing method of the system for collecting and analyzing user information and for marketing of example 1. This method uses multiple information carriers to collect information, and according to the times that a same mobile terminal accessed the multiple information carriers, analyzes the degree of attentions that the mobile terminal user pays to the different information carriers and the related advertisements, and therefore transmits the advertisement information to the mobile terminal according to predetermined or instantly inputted conditions. For example, some user accessed ten information carriers in one month, wherein five were advertisements of automobile category, and then the system would determine that the user paid more attention to automobile, and therefore transmits the advertisements of the automobile category to this mobile terminal.

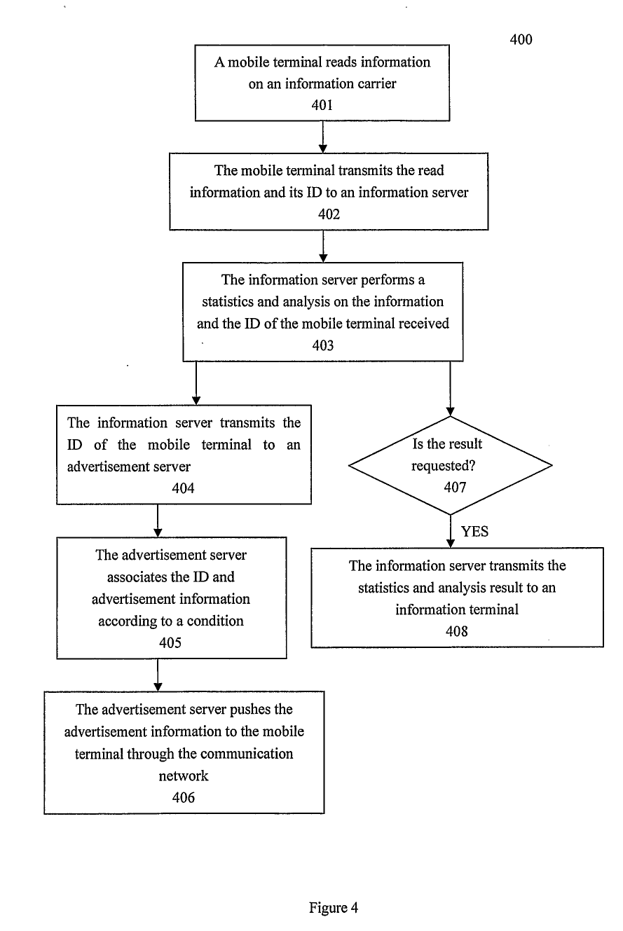

FIG. 4 is a flow chart 400 showing a method for collecting and analyzing user information and for marketing. At 401, a mobile terminal reads information on an information carrier, and then at 402, the mobile terminal transmits the read information and its ID to an information server. The information server performs a statistics and analysis on the information and the ID of the mobile terminal received (403). At this point, if an information terminal requests for the result (the answer to the decision block 407 is ‘YES’), the information server transmits the statistics and analysis result to the information terminal. In addition, after 403, the information server may transmit the ID of the mobile terminal to an advertisement server (404). Subsequently, the advertisement server associates the ID and advertisement information according to a condition (405) and pushes the advertisement information to the mobile terminal through the communication network (406). It should be appreciated that the execution sequence for the process blocks 404 and 407 is not limited and the executions thereof are independent. They may be executed at same time, or they may be executed at any desired time.

More applications may occur to those skilled in the art. As mentioned above, based on the analysis results, the advertisement server may choose different advertisements to be associated with the ID of the mobile terminal. If the ID includes the model of the mobile terminal, the advertisement server may not just choose the advertisement contents but also the forms of advertisements. Specifically, by analyzing the models of the mobile terminals, the advertisement server may decide to send advertisements with just texts to mobile terminals of certain models or otherwise to send advertisements in the form of video and/or audio to other mobile terminals, depending on different functions of the mobile terminals which can be obtained from the models information.

Further more, the system of the present invention may function differently depending on information educed from the ID of the mobile terminal. For example, the system may determine the degree of user attentions to one piece of (or a kind of) information at specific areas. To achieve this purpose, the mobile terminal may send its Location Area Code in the ID information, and based on the location information, the information server may analyze that users in which areas are more interested in which kind of information. Based on the analysis, the information distributor may adjust his distribution scheme. Just as an example, if the analysis suggests that users in western town are more interested in cultural information, whereas users in eastern town pay more attention to shopping information, then the distributor may decide to distribute more cultural information at western town and more shopping information at eastern town.

As will be appreciated by those skilled in the art, although the advertisement server is described herein to be used for pushing advertisements to users, the present invention is not so limited. The advertisement server may be a content server for storing and sending any appropriate contents, and the manner for sending contents may be any manner known in the art or developed in the future. The information server in this invention is used as an analyzing server for performing analysis and statistics. In addition, the advertisement server and the information server may be the same server, and the present invention is not limited in this respect. All other variations fall into the scope of the invention.

Whereas many alterations and modifications of the present invention will become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

What is claimed is:

1. A system for collecting and analyzing user information, comprising:
an information carrier, for carrying information;
a mobile terminal, comprising:
an information reading apparatus for reading information on the information carrier, and
an ID storing device for storing the ID of the mobile terminal;
a communication network; and
an information server which receives the information on the information carrier and the ID of the mobile terminal from the mobile terminal through the communication network, and performs a statistics and analysis thereon.

2. The system of claim 1, further comprising an advertisement server, which receives the ID of the mobile terminal from the information server and transmits advertisement information to the mobile terminal through the communication network, the advertisement server comprising:
an storing device for storing the advertisement information and the ID;
an associating apparatus for associating the ID and the advertisement information according to a condition; and
a transmitting apparatus for pushing the advertisement information to the mobile terminal through the communication network according to the associated ID and the advertisement information.

3. The system of claim 2, further comprising an information terminal which requests that the information server transmits the statistics and analysis result to the information terminal and controls the information server and the advertisement server.

4. The system of claim 1, wherein the ID of the mobile terminal is selected from a group consisting of mobile terminal number, mobile terminal model and the combination thereof.

5. The system of claim 1, wherein the information reading apparatus includes a non-contact automatic identifying apparatus, which is selected from a group consisting of a digital camera, a barcode identifying device and a RFID identifying device.

6. A method for collecting and analyzing user information, comprising:
a mobile terminal reading information on an information carrier;
the mobile terminal transmitting the read information and its ID to an information server through a communication network; and
the information server performing a statistics and analysis on the information on the information carrier and the ID of the mobile terminal received.

7. The method of claim 6, further comprising:
the information server transmitting the ID of the mobile terminal to an advertisement server;
the advertisement server associating the ID and advertisement information; and
pushing the advertisement information to the mobile terminal through the communication network according to the associated ID and advertisement information.

8. The method of claim 6, further comprising:
an information terminal requesting that the information server transmits the statistics and analysis result to the information terminal, and controlling the information server and the advertisement server.

9. The method of claim 6, wherein the ID of the mobile terminal is selected from a group consisting of mobile terminal number, mobile terminal model and the combination thereof.

10. The method of claim 6, wherein the information reading apparatus includes a non-contact and automatic identifying apparatus which is selected from a group consisting of a digital camera, a barcode identifying device and a RFID identifying device.
